(19) United States
(12) Patent Application Publication
(10) Pub. No.: US 2011/0289739 A1
(43) Pub. Date: Dec. 1, 2011

(54) Clip for Electronic Book Reader and Cover

(76) Inventor: Mark E. Diehl, Charlotte, NC (US)

(21) Appl. No.: 12/788,601

(22) Filed: May 27, 2010

(51) Int. Cl. F16B 2/24; F16B 2/22

(52) U.S. Cl. 24/457

(57) ABSTRACT

A clip for securing electronic readers to their covers substantially precludes lifting the reader off its cover and breaking the attachment of the reader to the cover, potentially damaging the reader. The clip comprises, in one embodiment, a generally C-shaped flexible and resilient plastic-coated fabrication having upper and lower transversely extending leg members extending in face-to-face relation from a horizontally extending supporting leg member to define an opening and passageway for receiving the assembly of an c-reader and end cover. The transversely extending leg members are bent toward each other at an angle to flexibly and resiliently receive the e-reader and cover assembly and to frictionally and securingly retain the assembly in the passageway. By slightly bending the transverse legs as needed, the clip can easily be installed and removed. The clip is designed for the Amazon® Kindle® and related models of e-readers and can be used with e-readers from other sources as well.

### FIELD OF THE INVENTION

This invention relates to electronic book readers, which are portable consumer electronic devices for receiving and reading text and images and sound through wireless internet access and for displaying electronically published materials; typically books, journals, newspapers, magazines, and multimedia presentations.

### BACKGROUND OF THE INVENTION

Electronic book readers (“e-readers”) have become enormously popular and demand is growing for them. One such e-reader and a leader in the market is the Amazon® Kindle® e-reader sold by Amazon.com. The Amazon Kindle has been offered in several models, including the original Kindle, Kindle 2, and Kindle DX. Apple Inc. has released the i-Pad portable electronic device to great acclaim.

Users of e-readers carry a vast library of reading materials, images, and music with them in a portable format. Accessories include cases, covers, stands, power adapters, USB cables, computer hardware, software, and software development kits for the development of content and service delivery across global computer networks, wireless networks, and electronic communications networks. The portable e-reader may include downloadable audio works, visual works, audiovisual works, and electronic publications featuring books, magazines, newspapers, periodicals, newsletters, journals and manuals on a variety of topics. The e-reader may also include application development computer software programs and computer software for transmitting, sharing, receiving, downloading, displaying and transferring content, including text, visual works, audio works, audiovisual works, literary works, data, files, documents, and electronic works.

Similar to the printer industry, in which the vendor primarily is rewarded through sales of cartridges and toner, not printers, the vendor of an electronic book reader typically is rewarded not by sales of e-reader devices, but by sales of downloadable content. Still, for the typical consumer, e-reader devices are not necessarily inexpensive, may not readily be replaced when damaged, and can cause stress to the consumer when damaged or when they fail prematurely.

The Amazon Kindle and related models and similar e-reader devices typically are purchased with a cover to which the device can be fixedly attached. The cover normally has two end covers, front and back, flexibly connected to a spine, and which open in the manner of a traditional book with pages to reveal the e-reader screen. A typical assembly is illustrated in FIG. 1, labeled “Prior Art.” The back end cover for the Kindle and related models has a stiffened and longitudinally extending attachment member along its vertical edge adjacent the spine that includes spaced-apart projecting hooked tabs for interlocking insertion into mated receivers located along one longitudinal edge of the e-reader device.

Problems have arisen in the attachment of e-readers to covers, illustrated in FIG. 2, labeled “Prior Art.” The front cover can be readily opened, but if the back end cover and e-reader device are separated without first removing the e-reader from the attachment member, as when the device is inadvertently lifted off the back cover, the stiff interlocking tabs can break the attachment to the e-reader device, cracking its housing or even the screen and permanently damaging the device, much to the distress of the owner.

A Seattle man is reported to have sued Amazon in a class action in U.S. District Court after his wife's Kindle screen cracked and the device failed to work. The class action suit indicated that the problem is somewhat widespread of inadvertent separation of the Kindle from its cover and consequential damages to the Kindle. At the time, Amazon charged a substantial replacement fee, but has since settled the litigation and now is believed to replace at no charge, though only through the warranty period, e-reader devices damaged as a result of separation from the cover.

Alternative covers have been designed, illustrated in FIGS. 3 and 4, including, respectively, prior art hook and loop fasteners for attaching the device to its back end cover and straps on the corners of the back end cover into which the corners of the device housing can be inserted, which have not entirely eliminated the problem of damage to the housing and raise additional problems.

It would be desirable to provide an alternative to the available solutions that is easy to use with existing or new designs of e-readers and covers, that provides ready access to the e-reader, and that securely, unobtrusively, and removably fastens the e-reader to its cover.

### SUMMARY OF THE INVENTION

The invention provides a device for retaining an electronic book reader in contact with its cover. The retaining device comprises at least one clip made from a flexible, resilient material and that has a generally C-shaped profile defining an interior opening and a passageway for insertion of an edge of the assembly of an e-reader housing and at least one end cover, thereby slidably and removably engaging the reader and cover assembly to frictionally and securingly retain the reader in contact with its cover. Separation of and attendant damage to the reader and cover are substantially reduced.

The C-shaped profile is formed by first and second transversely extending leg members secured to a longitudinally extending supporting leg member at opposite ends thereof. The ends of the transverse leg members opposite the longitudinally extending leg member define the opening of the passageway into which is inserted the assembly of the e-reader housing and cover. The opening of the passageway is normally of somewhat less cross-sectional dimension than the cross-sectional dimension of the assembly of an e-reader and cover for flexible expansion of the opening to enlarge the opening during insertion and removal. The material provides for resilient contraction of the clip when the assembly of e-reader and cover is inserted into the passageway, returning the opening upon insertion to frictionally and securingly retaining the cover and e-reader assembly in the passageway and adjacent the longitudinally extending leg.

The transversely and longitudinally extending leg members generally form an integral unit fabricated from one piece of flexible and resilient material, such as stainless steel. The transverse leg members can be bent slightly outwardly for ease in accommodating inserting the edge of the e-reader and cover assembly and for ready removal of the assembly. The legs can be bent slightly inwardly to more securely grip the e-reader to its cover and to reduce the possibility of inadvertent removal.

In one embodiment, the clip comprises stainless steel plate material. The clip may be plastic coated, if desired, to avoid marring the e-reader housing, using any suitable technique.

In another embodiment, the clip comprises a generally block C-shaped configuration, resembling the top, bottom and one side of a cube. The length of the transversely extending leg members generally allows the assembly of the e-reader and cover edge to be inserted fully into the passageway without the transversely extending leg member in contact with the e-reader housing to cover any portion of the screen or any of the switches or buttons used to operate the e-reader, or to otherwise interfere with use of the e-reader. The width of the leg members, including the width of the longitudinally extending leg member, may be of a similar measure in the case of a cube-shaped structure or wider or narrower as desired in the more generally C-shaped configuration. A more rectangular shape may be desired for placement of advertising indicia, for example. Typically, the dimensions of the clip will be controlled for accommodating the edge of the e-reader housing and one end cover, normally the back cover, and the longitudinally extending leg will thus be of a length that is nominally similar to the thickness of the housing and one end cover, assembled together with the edges of the e-reader and cover more-or-less in alignment. It should be recognized that, if desired, the clip can be of a dimension to hold both the front and back end covers secured and requiring removal of the clip to open the cover.

The invention also includes a method for retaining an e-reader in contact with its cover to reduce the likelihood of damage to the e-reader by inadvertently lifting the e-reader off its cover. The e-reader is assembled with the cover and the user slides at least one clip over a portion of the edge of the conjoined cover and e-reader to frictionally and securingly retain the e-reader in contact with its cover in conjoined relation. The transversely extending legs can be bent inwardly as needed to more securely hold the e-reader and its cover and can be bent slightly outwardly for ease in removal.

Thus, the invention provides, among other things, a C-shaped, plastic-coated clip of a flexible and resilient steel to avoid inadvertent separation of an e-reader from its cover, the clip having transversely extending leg members extending from a longitudinally extending supporting leg member to define an opening and a passageway for receiving an assembly of an e-reader and at least one end cover, typically the back end cover, where the opening is of somewhat less cross-sectional dimension than the cross-sectional dimension of the assembly of an e-reader and cover for flexible expansion of the opening to enlarge the opening during insertion and removal and to provide for frictionally and securingly retaining the cover and e-reader assembly in the passageway and adjacent the longitudinally extending supporting leg.

### BRIEF DESCRIPTION OF THE DRAWINGS

FIG. 1 is labeled “Prior Art” and illustrates in perspective an e-reader attached to its cover;

FIG. 2 is labeled “Prior Art” and illustrates in perspective the e-reader of FIG. 1 separated from its back cover;

FIG. 3 is labeled “Prior Art” and illustrates in exploded perspective an e-reader and cover having corresponding hook and loop fasteners on the inside face of the back cover and facing back surface of the e-reader;

FIG. 4 is labeled “Prior Art” and illustrates in perspective an e-reader and cover where the cover includes corner loop tabs into which the corners of the e-reader can be inserted;

FIG. 5 illustrates in perspective one embodiment of the clip of the invention into which has been fully inserted an assembly of an e-reader and its back cover;

FIG. 6 illustrates in isolated perspective insertion of the assembly of an e-reader and cover into the clip of the invention;

FIG. 7 illustrates in perspective the clip of the invention;

FIG. 8 illustrates in a top plan view the clip of the invention;

FIG. 9 illustrates in a side plan view the clip of the invention;

FIG. 10 illustrates in a rear plan view the clip of the invention; and

FIG. 11 illustrates in a front plan view the clip of the invention.

Corresponding reference characters indicate corresponding parts throughout the several views of the drawings.

### DETAILED DESCRIPTION

This invention can best be understood with reference to the specific embodiments that are illustrated in the accompanying drawings and the variations described below. While the invention will be so described, it should be recognized that the invention is not intended to be limited to the embodiments illustrated in the drawings. On the contrary, the invention includes all alternatives, modifications, and equivalents that may be included within the scope and spirit of the invention as defined by the appended claims.

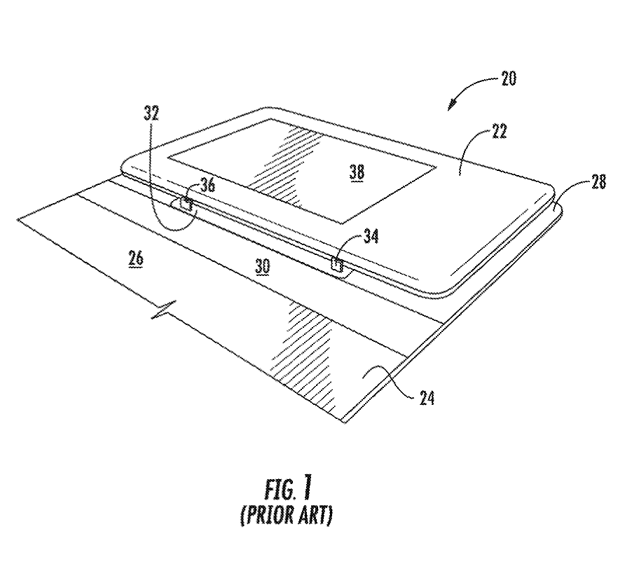

Turning first to a discussion of the context in which the clip of the invention is intended for use and the need the clip is designed to solve, FIG. 1 illustrates generally at 20 a typical e-reader 22 in perspective, such as a Kindle or related model, attached to a cover 24, and exemplifies the prior art. The cover includes a front end cover 26, shown in partial perspective, a back cover 28 adjacent the e-reader, and a spine 30 joining the front and back end covers. A longitudinally extending stiffened attachment member 32 is fixedly attached to the back end cover adjacent the spine for binding the e-reader to the back end cover. Tabs 34 and 36 extend from the stiffened attachment member 32 into mating and interlocking receivers on the edge of the e-reader to secure the e-reader to the cover. As illustrated, the front end cover is open to reveal the display screen 38 of the e-reader. It should also be recognized that the stiffened attachment member 32 and tabs 34, 36 could be placed in other locations on the cover to accommodate mating and interlocking receivers on the e-reader.

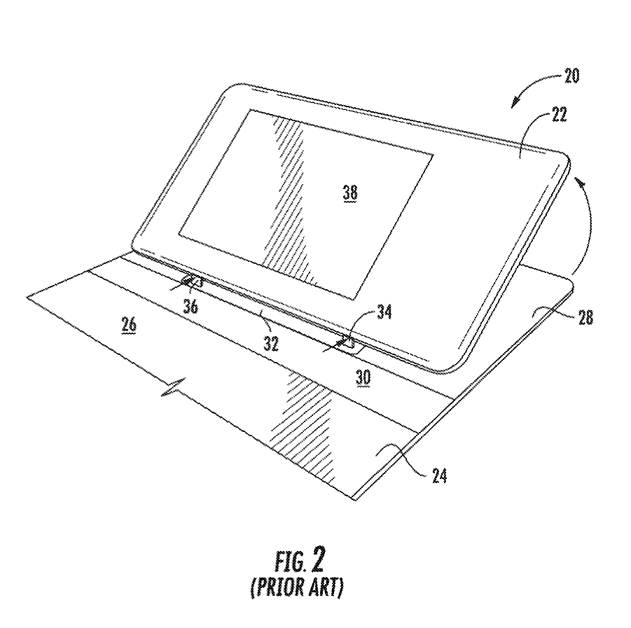

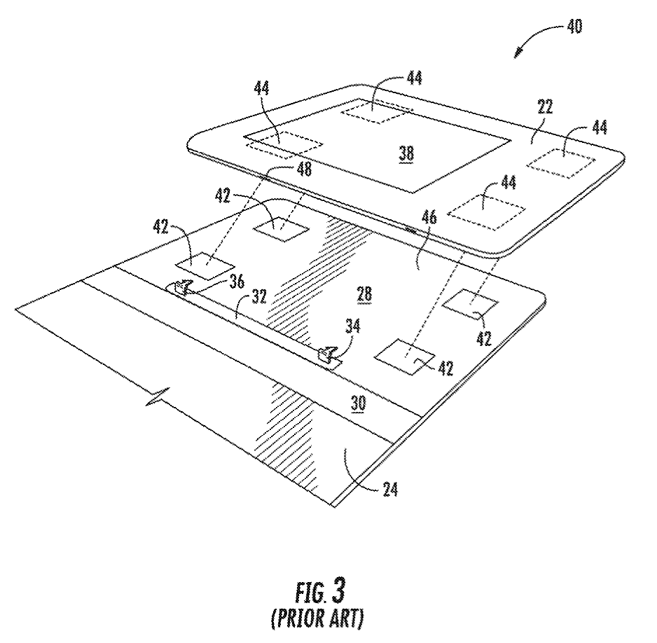

Tabs 34 and 36 typically are metal or some other suitable stiff material. The e-reader housing typically is a rigid plastic. As illustrated in the prior art, FIG. 2, when the e-reader is lifted off the back end cover, the plastic housing is placed at an angle to the tabs, the location of which is indicated by the arrows in FIG. 2, and the tabs can break or, more typically, break or crack the housing. One prior art modification to avoid inadvertently lifting the e-reader off its attached cover is illustrated in FIG. 3, shown generally at 40. Hook and loop fasteners 42, 44, such as Velcro® fasteners, are placed to affix the back cover 28 to the facing back of the e-reader 22. FIG. 3 also illustrates the receivers 46, 48 located along the longitudinal edge of the e-reader housing 22 for receiving tabs 34, 36, respectively, in a mating and interlocking relation.

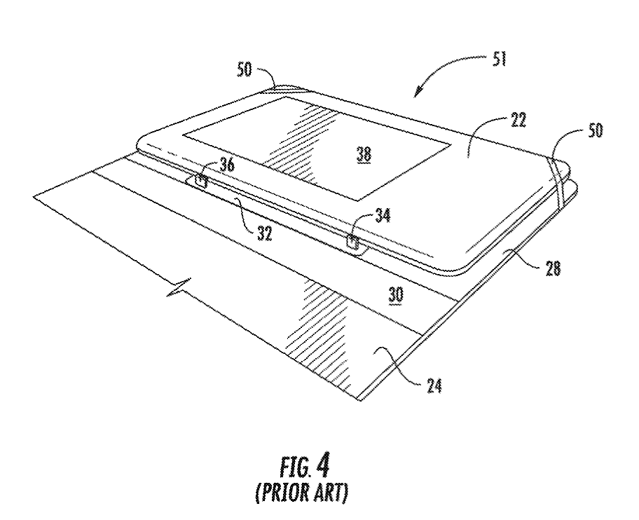

FIG. 4 illustrates generally at 51 an alternative prior art solution to that of FIG. 3 in which the e-reader housing, attached to the back end cover as in FIGS. 1 through 3, is further secured in place by plastic corner straps 50 affixed to the back end cover and into which are inserted the corners of the e-reader housing.

None of these prior solutions is entirely satisfactory. Hook and loop fasteners detract from the desirable slim profile of the e-reader and can make it difficult to release the e-reader from the cover. Corner straps typically are plastic or even an elastic band material and can stretch over time or otherwise fail adequately to secure the e-reader to its cover.

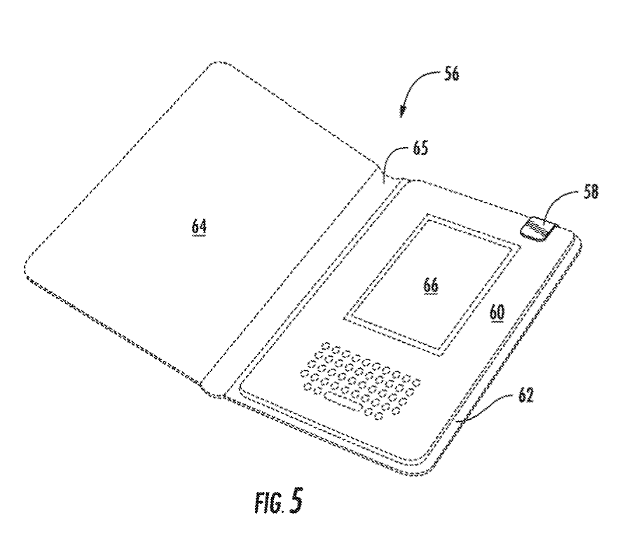

Turning now to a discussion of the invention in its context of use as outlined above, FIG. 5 illustrates in perspective generally at 56 an embodiment of the clip 58 of the invention into which has been inserted an assembly of an e-reader 60 and its back end cover 62, the e-reader and cover illustrated in dashed lines. The front end cover 64 has been opened to reveal the cover spine 65 and the e-reader and its display screen 66 and to show the insertion of the clip along the upper right-hand edge of the e-reader 60 and back end cover 62 assembled in combination. The clip is unobtrusive and does not extend into the display screen area. The clip takes up only a minor portion of space on the surface of the e-reader housing. It should be recognized that the clip could be placed at a number of locations about the upper or lower transverse and right-hand longitudinal edges of the e-reader housing and back end cover, as desired, and without interfering with the operation and display of the e-reader.

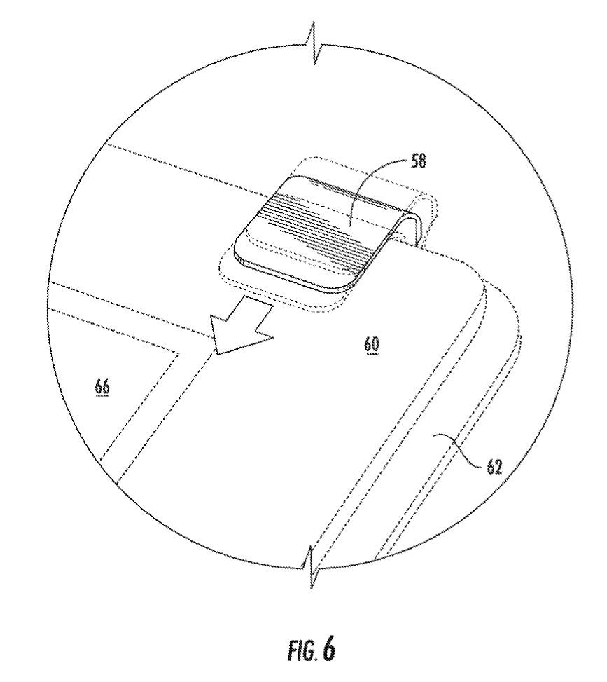

FIG. 6 isolates the upper right hand corner of the view illustrated in FIG. 5 to illustrate insertion of the assembly of the e-reader housing 60 and end cover 62 into the clip 58. The user slides clip 58 into place and can remove the clip in the reverse manner. It should be recognized that the clip can be installed at multiple locations about the periphery of the end cover and e-reader housing assembly, and multiple clips may be used, as desired.

FIG. 7 illustrates in a perspective view one embodiment of a single clip of the invention, which is shown generally at 70. A single piece of spring stainless steel plate, known as “half hard” steel in the steel fabricating industry, forms the clip and has been bent into a generally C-shaped retaining device. Other materials could be used, the main criterion being that the material is sufficiently flexible and resilient. Flexibility is also dependent on the thickness of the material, thinner material typically being more flexible. A suitably flexible spring stainless may have a nominal thickness of twelve to eighteen thousandths. Fifteen thousandths, which is 0.015 inches, has been shown to be particularly desirable for spring steels. Other dimensions may be used as well depending on the flexibility desired and the material.

The clip desirably is coated after bending to avoid marring the surface of the e-reader housing. The coating normally is plastic applied by any of several techniques, including hot melt vinyl and powder coatings. Fluidized bed plastic coatings in which the thickness of the coating is controlled by the temperature of the fabrication to be coated and time of immersion in the fluidized bed, are particularly useful. The plastic typically will be a soft non-marring vinyl and may comprise any of several polyolefins known in the industry. Various suitable mixtures of polyethylene and polypropylene are widely available. The coating selected should be one that won't crack when the clip is bent, that does not slip on the surface of the e-reader housing, and that readily accepts and retains advertising indicia if such indicia are desired.

Clip 70 comprises transversely extending upper and lower facing leg members 72 and 74, respectively, bendably attached to a longitudinally extending supporting leg 76. The longitudinally extending supporting leg optionally may have finger grooves 76′ and 76″ provided thereon for ease of grasping the clip for insertion and removal of the assembly of an e-reader and its cover. Nominal dimensions for a cube-shaped clip designed for the Amazon Kindle e-reader and models of similar dimensions and to fit the assembly of one end cover layer and the e-reader housing include a length from the back face of the supporting leg member to the front edge of each transversely extending leg member of about 0.60 inches. The supporting leg member is of a height from the top of the upper leg member to the bottom of the lower leg member of about the same dimension. The width of the longitudinally extending supporting leg member at its widest dimension and of the upper and lower transverse leg members are of a similar dimension to complete the cube. In a specific embodiment, the length and width are about 0.63 inches and the height of the clip is 0.62 inches after bending. It should be recognized that in this context, “bending” refers to fabricating the clip from a piece of steel plate, not to slightly bending the transversely extending leg members for adjustments for inserting and removing the assembly of an e-reader and cover. It should also be recognized that the width may be longer or narrower as desired, creating a more rectangular shape. For example, it may be desirable to increase the width of the upper or lower transversely extending leg member or that of the longitudinally extending surface, independently or together, to support advertising indicia. The length can be somewhat longer if desired, although typically covering a portion of the screen or buttons or switches is to be avoided. The length of the lower transverse leg member can be made somewhat longer than the upper member since it is in contact with the cover, so long as the opening of the passageway defined by the leg members retains its ability to secure the cover and e-reader together. The height of the supporting leg member can be modified for varying thicknesses of e-reader and cover assembly or to clip both end covers with an e-reader sandwiched in between, if desired.

The clip desirably may also have a radius 78 applied for comfort and appearance and to avoid sharp edges. The radius may be applied to the edges of the ends of the transversely extending legs at the corners opposite the horizontally extending supporting leg.

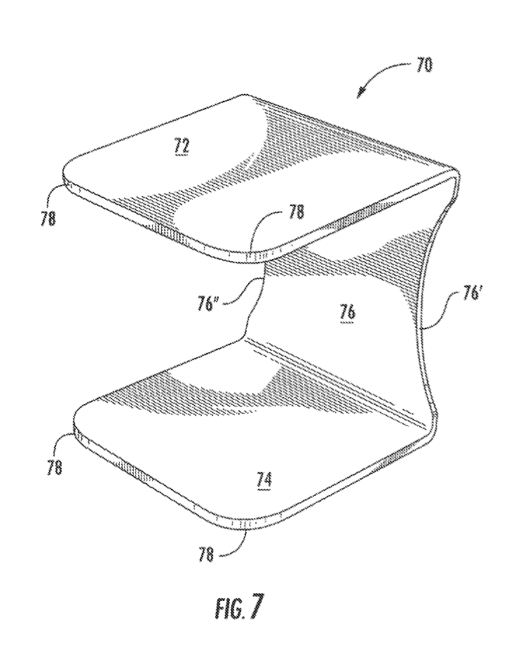

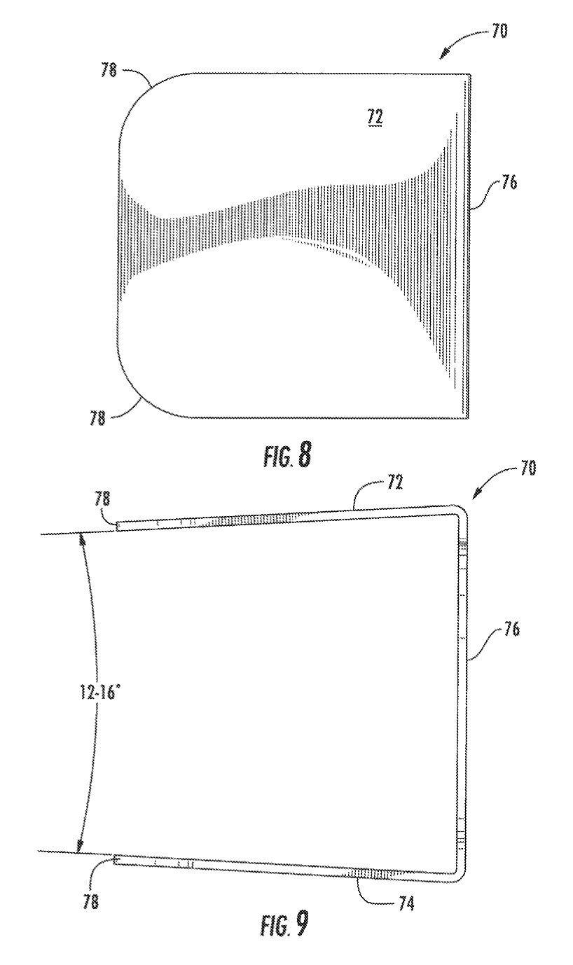

FIG. 8 illustrates a top plan view of the clip of FIG. 7 shown generally at 70 and having an upper transversely extending leg member 72 and radiused edge portions 78 opposite the longitudinally extending supporting leg member 76. A side plan view of the clip of FIGS. 7 and 8 is illustrated in FIG. 9, which also includes the lower transversely extending leg member 74. As illustrated in FIG. 9, the upper and lower transversely extending leg members extend from the longitudinally extending supporting leg member 76 in face-to-face relation defining a passageway for insertion of an assembly of an e-reader and its cover. The radiused ends 78 define an opening for receiving the assembly of the e-reader and cover. Typically, the assembly is inserted into the passageway with the upper transversely extending leg member 72 slidingly engaging the e-reader housing and the lower facing leg member 74 slidingly engaging the back end cover to abut the longitudinally extending supporting leg 76 at the rear-most portion of the passageway.

The clip is fabricated so that the face-to-face transversely extending leg members bend toward each other, as illustrated in FIG. 9. Thus, the opening of the passageway is somewhat smaller than the passageway and the passageway continuously enlarges toward the longitudinally extending supporting leg member 76. The material from which the clip is fabricated, including, for example, a spring steel, provides flexibility and resilience to the transversely extending leg members so that the opening enlarges slightly to accommodate insertion of the e-reader and cover assembly and exerts a slight pressure on the e-reader housing and cover to frictionally and securingly retain the assembly within the passageway. The legs 72 and 74 can be slightly bent, if desired, to enlarge the opening for ease of insertion, and, if needed, pressed inwardly after insertion to more securely grip the e-reader housing and cover. The legs can also be bent slightly for ease of removal, if desired. Typically, the angle at which the legs face each other at fabrication should be selected depending on the thickness of the material from which the clip is made and its flexibility and resilience. For fifteen thousandths half hard spring steel plate, a suitable angle is from 12 to 16 degrees, and 14 degrees has been shown to be particularly suitable.

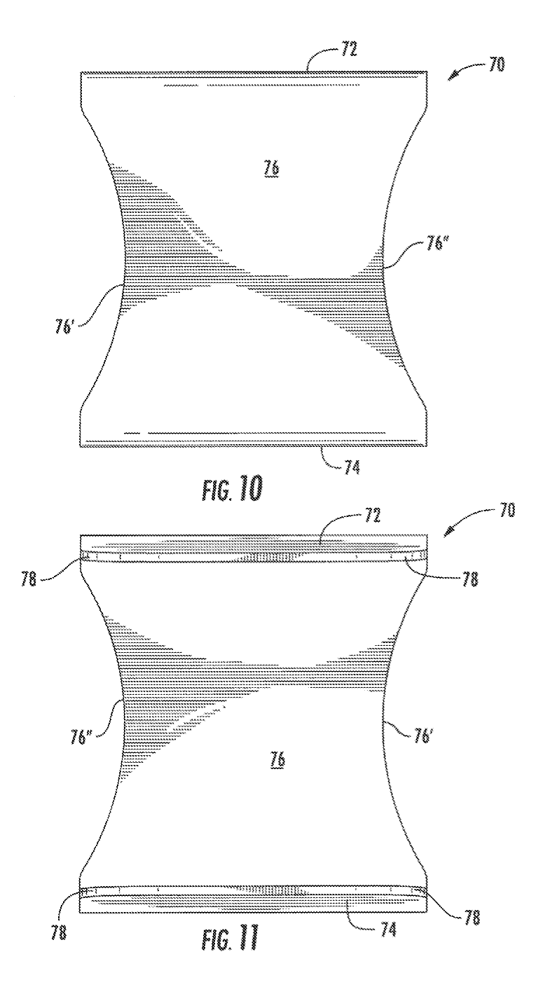

FIGS. 10 and 11 illustrate rear and front plan views, respectively. Shown generally at 70 in FIG. 10 is a rear plan view of the clip of FIGS. 7, 8, and 9, in which longitudinally extending supporting leg 76 faces the viewer with upper and lower transversely extending leg members 72 and 74, respectively, directed in a plane away from the viewer. The rear plan view of FIG. 10 has been rotated 180° to illustrate the front plan view in FIG. 11, in which the upper and lower transversely extending legs 72, 74, respectively, extend toward the viewer and the viewer looks directly into the opening and passageway defined by the inwardly bent, face-to-face transverse leg members and into which the assembly of an e-reader and end cover may be inserted.

What is claimed is:

1. A device for retaining an electronic book reader (“e-reader”) in contact with a cover for the e-reader, the retaining device comprising at least one clip adapted for slidably and removably engaging the assembled e-reader and cover, the clip comprising a flexible, resilient material and having a generally C-shaped profile defining an interior opening and a passageway for insertion of an edge portion of the assembly of an e-reader and at least one end cover, the clip being characterized by frictionally and securingly retaining the e-reader in the passageway in contact with its cover, thereby substantially reducing separation of and attendant damage to the e-reader and cover.

2. The device of claim 1 wherein the clip further comprises upper and lower transversely extending leg members extending from a longitudinally extending supporting leg member, the transversely extending leg members extending in face-to-face relation and defining the opening and passageway into which an edge portion of e-reader and cover may be inserted in assembled relation.

3. The device of claim 2 wherein the clip is adapted for engaging an e-reader and back end cover, the upper leg member slidably engaging the e-reader opposite the back end cover and the lower leg member slidably engaging the cover opposite the e-reader.

4. The device of claim 2 wherein the clip is adapted for engaging the assembly of an e-reader sandwiched between its front and back end covers, the upper leg member slidably engaging the front end cover and the lower leg member slidably engaging the back end cover.

5. The device of claim 2 wherein the longitudinally extending supporting leg member is of a length of about the distance from the top surface of an e-reader to the cover opposite the top surface and in contact with the e-reader and cover assembly to provide the clip for slidably and removably engaging the e-reader and cover.

6. The device of claim 2 having the general appearance of three sides of a cube.

7. The device of claim 2 wherein the transversely extending legs are bent toward each other at an angle of about 12 to 16 degrees to define an opening that is the narrowest portion of the passageway.

8. The device of claim 7 wherein the angle is about 14°.

9. The device of claim 2 wherein the longitudinally extending supporting leg member further comprises finger grooves on opposite sides thereof for gripping the clip for slidably and removably engaging the reader and cover with the clip.

10. The device of claim 1 wherein the clip comprises spring steel.

11. The device of claim 10 wherein the clip is spring steel plate of fifteen thousandths thickness.

12. The device of claim 1 wherein the clip comprises half hard stainless steel.

13. The device of claim 1 wherein the clip is from about 12 to 18 thousandths in thickness.

14. The device of claim 1 wherein the clip is plastic coated.

15. The device of claim 1 wherein the clip is hot-melt vinyl coated.

16. A device for retaining an e-reader in contact with one end cover, the end cover having a spine for attachment of the e-reader, the retaining device comprising at least one plastic-coated, flexible and resilient stainless-steel clip having generally a C-shape and comprising upper and lower transversely extending leg members extending from a longitudinally extending supporting leg member in face-to-face relation and bent toward each other at an acute angle to define an opening and a passageway tapered outwardly from the opening for receiving the assembly of an e-reader and its end cover, the opening and passageway flexibly and resiliently expanding to accommodate insertion of the e-reader and end cover assembly and frictionally and securingly retaining the inserted e-reader in contact with its cover, thereby substantially reducing damage to the reader by precluding lifting the reader off the cover.

17. The assembly of an e-reader, end cover, and a device for retaining the e-reader in contact with its cover, the retaining device comprising at least one clip adapted for slidably and removably engaging the e-reader and its cover, the clip comprising a flexible, resilient material and having a generally C-shaped profile defining an interior opening and a passageway for insertion of an edge portion of the assembly of an e-reader and at least one end cover, the clip being characterized by frictionally and securingly retaining the e-reader in the passageway in contact with its cover, thereby substantially reducing separation of and attendant damage to the e-reader and cover.

18. A clip having a generally C-shaped profile and made of a flexible and resilient material, the clip comprising upper and lower transversely extending leg members extending from a longitudinally extending supporting leg member in face-to-face relation and bent toward each other at an acute angle to define an opening and a passageway tapered outwardly from the opening for receiving an object to be clipped thereby, the opening and passageway flexibly and resiliently expanding to accommodate insertion of one or more objects to be clipped and frictionally and securingly retaining the one or more objects.

19. A method for retaining an e-reader in contact with its cover and thereby substantially reducing damage to the e-reader and cover by lifting the e-reader off the cover, the method comprising the steps of attaching an e-reader to its cover and sliding at least one clip over a portion of the edge of the e-reader and an adjacent portion of the edge of the cover opposite the e-reader, the clip frictionally and securingly retaining the e-reader in contact with its cover.

20. The method of claim 19 wherein the step of sliding the clip over a portion of the edge of the e-reader and adjacent cover edge portion comprises sliding the clip over a portion along the upper-most edge of the e-reader and its cover.

21. The method of claim 19 further comprising the step of determining that no button or control of the e-reader is blocked by the clip.

22. The method of claim 19 wherein the clip is stainless steel and includes transversely extending leg members, the method further comprising the step of manually spreading the legs apart sufficiently for sliding the clip over a portion of the edge of the e-reader and an adjacent portion of the edge of the cover opposite the e-reader, thereby frictionally and securingly retaining the e-reader in contact with its cover.

23. The method of claim 19 further comprising the step of removing the clip from securing engagement with the e-reader and cover.

24. The method of claim 23 further comprising the step of removing the clip, and the step of removing the clip comprises manually spreading the transversely extending legs apart sufficiently for sliding the clip off the reader and cover.
